(19) United States
(12) Patent Application Publication
(10) Pub. No.: US 2007/0137063 A1
(43) Pub. Date: Jun. 21, 2007

(54) Carbon beam deposition chamber for reduced defects

(75) Inventors: Donald K. Grubbs, San Jose, CA (US); Eric Hwang, San Francisco, CA (US); Jinliu Wang, San Jose, CA (US); Richard Longstreth White, Los Altos, CA (US)

Correspondence Address: MINTZ, LEVIN, COHN, FERRIS, GLOVSKY AND POPEO, P.C, 1400 PAGE MILL ROAD, PALO ALTO, CA, 94304-1124, US

(73) Assignee: Hitachi Global Storage Technologies Netherlands, B.V., Amsterdam (NL)

(21) Appl. No.: 11/315,647

(22) Filed: Dec. 21, 2005

(51) Int. Cl. F26B 3/00; F26B 5/04

(52) U.S. Cl. 34/406; 34/443

(57) ABSTRACT

The improved carbon beam deposition chamber described herein substantially reduces the accumulation of carbon film on the outer surfaces of the chamber aperture plates, thereby substantially increasing the number of disks which can be processed before system cleaning or hardware replacement is required, thereby to substantially reduce disk failure for coated disks and substantially increase carbon gun productivity.

### TECHNICAL FIELD

This invention relates generally to ion beam deposited carbon overcoats, and in particular to means for minimizing harmful defects on thin film disks coated with ion beam deposited carbon overcoats.

### BACKGROUND AND SUMMARY OF THE INVENTION

The demand for increasingly higher area storage densities on applied film disks implies a reduction of the magnetic distance between the read/write head and the disk of a data storage device. Although it is possible to improve data density on thin film storage media by the reduction of the altitude of the read/write head over the magnetic storage disk, a more likely solution is the reduction of the thickness of the magnetically inactive carbon-based protective film applied to the disk.

It is particularly desirable that the carbon based protective film applied to storage media be extremely thin. Further, it is particularly desirable that this carbon based protective film be exceedingly tough, approaching diamond-like hardness. Another particularly desirable quality of such carbon based protective film is a relatively smooth surface, enabling smooth transit of a read/write head over the disk.

Reducing the thickness of the diamond-like carbon protective overcoat on storage media to a thickness of 2-3 nm is one major key to increase the recording density of magnetic disk drives. Plasma enhanced chemical vapor deposition (PECVD) provides carbon based layers on storage media which have been shown to be denser and harder than those produced by conventional sputter deposition.

A plasma is an “ionized” gas which is so hot that the atoms of such plasma lose some of their electrons and become electrically charged.

Ion beam processing has many applications in microelectronics device fabrication. Ionized gases may be used to modify the electrical properties of a semiconductor substrate as shown in U.S. Pat. No. 6,355,933 and US 2005/0016838. Ion beam processing may also be used, for example, in the production of high frequency microwave integrated circuits and thin magnetic heads, and in the application of thin-film coatings to magnetic disks which are an integral element of data storage devices, i.e., disk drives.

There are two basic configurations for ion beam deposition. In “secondary ion beam deposition,” or “ion beam sputtering,” an ion beam comprising particles which are not essential to the deposited film are directed at a target of the desired material so as to sputter it, with the sputtered target material being collected on the substrate. Secondary ion beam deposition can be a completely inert sputtering process. Alternatively, certain chemicals can be added to the ion source or elsewhere in the deposition chamber to alter the chemical properties of the deposited film either by reaction with the target material or with the substrate. This can be done with or without energetic activation by the ion source plasma or the ion beam.

In the configuration of the present invention, which is commonly known as “primary” or “direct” ion beam deposition, ion beams can be used for thin film deposition. In the carbon gun associated with the present invention, an ion beam source is used to produce a flux of particles, including constituents of the desired film, which are accumulated at the substrate. In this type of “primary” ion beam deposition, the deposited material is formed by reactive means from precursor chemicals introduced to the ion source, in the gaseous phase. A diamond-like carbon film is produced by direct ion beam deposition from an ion source operated on a hydrocarbon gas, in this instance, acetylene.

The problem addressed in the present invention is the accumulation of plasma material, in this case carbon-based plasma material, on the inner walls of the chamber in which such ion beam deposition occurs. In particular, the carbon gun which delivers a thin film, diamond hard carbon coating to a magnetic read/write disk in a controlled manner through ionization of a precursor acetylene gas and impelling the carbon ions so released onto the disk also causes carbon ions to attach to the walls of the interior space of the gun in which the ionization chamber is housed, to the walls of the ionization chamber itself, to a beam collimating ring disposed in an annular opening in an aperture plate disposed in a forward end of the housing which directs the ion beam flow during the carbon deposition process and to the aperture plate as well.

Of particular concern is the interface between the aperture plate and the beam collimating ring. An annular opening in the aperture plate holds the beam collimating ring during the carbon deposition cycle of the carbon gun. An o-ring is placed between the aperture plate and the beam collimating ring to seal that interface during the coating cycle of the carbon gun.

It is known to irrigate the plasma chamber with a cleansing gas in an effort to remove particles which have attached to the chamber walls during a deposition cycle; e.g., see U.S. Pat. No. 6,355,933 to Tripsas et al., in which a method for removal of contaminants from ionization walls is set forth as follows:
A method for reducing contaminant formation within an ion source having a chamber and a filament contained therein comprises: reducing the pressure of the chamber to below atmospheric pressure; introducing a feed material to the chamber; introducing an oxygenated gas to the chamber; applying electrical power to the filament to form ions of the feed material; and reacting the oxygenated gas with contaminant forming deposits within the chamber. The method advantageously comprises reacting the oxygenated gas with polymer forming ions or radicals, or with metal forming deposits within the chamber thereby preventing damaging deposits from coating structural elements in the chamber and decreasing the life-time of the ion source.

Other patents which show either ion beam deposition of plasma particles and/or a chamber cleaning process associated therewith include Japanese Patent No. JP20011254179 to Takahiro et al, the reference “In Situ Oxygen Plasma Cleaning of a PECVD Source for Hard Disk Overcoats” by D. Ochs and B. Cord and published in Appl. Phys. A 78, 637-639 (2004), U.S. Pat. No. 5,858,477 to Veerasamy et al, Japanese Patent No. JP211229150 to Naiko et al. and U.S. Pat. No. 6,772,776 to Klebanoff et al.

The substantial increase in productivity of the carbon gun, which results from reducing the accumulation of carbon particles on the exterior of the gun during coating cycles, where such particles can produce especially harmful defects on thin film disks coated with ion beam deposited carbon overcoats is a significant feature of the present invention. The carbon particles can also attach to the surface of a thin film disk prior to the coating stage of the processing of a thin film disk and can be especially deleterious because such particles cause defects which are not detectable by the normal disk and file detect mapping techniques. These particles have been demonstrated to lead to disk drive failure during file corrosion testing.

The carbon gun to which this invention is related has been designed by the Unaxis Corporation. The interior space of the gun holding the ion deposition chamber and the chamber itself initially received large numbers of carbon particles deposited thereon after relatively short operation times. Carbon films which attached to the walls of the interior space and the chamber during a coating cycle of the apparatus would produce carbon particles which would attach to the thin film coating of the disk and potentially cause disk drive failure in the finished disk drive assembly. Of particular concern were carbon particles which attached to the beam collimating ring and the aperture plate.

To reduce the formation of these particles, the Unaxis Corporation had designed the carbon gun to allow for an oxygen cleaning step after a series of carbon deposition cycles to remove extraneous deposits of carbon films within the carbon gun deposition chamber which eventually lead to the formation of carbon particles.

This design modification of the Unaxis carbon gun substantially reduced the formation of carbon particles within the carbon deposition chamber.

However, this design modification didn't eliminate the formation of carbon deposits on the surfaces of the carbon gun which are exterior to the etching chamber. Such deposits form when the carbon ion beam scatters after passing the disk outer edge. Because these deposits are relatively high stress, spallation (delamination and removal from the deposition surface) occurs after relatively short operation times, leading to unacceptably high levels of carbon particles in the chamber during the carbon deposition cycle, such particles attaching to the disk surface during the deposition of the carbon overcoat film to the disk.

The structure described below substantially reduces the accumulation of carbon film on the outer surfaces of the chamber aperture plates, thereby to substantially reduce disk failure for coated disks and substantially increase gun productivity.

The carbon gun is an add-on module to a Unaxis Circulus carbon deposition tool. During a gun cleaning cycle, a cover plate or shutter of the carbon gun in combination with a movable beam collimating ring of the carbon gun separate the interior space housing the carbon gun from the deposition chamber which holds the disk. The cleaning cycle is initiated when the beam collimating ring is pulled out of the opening in the aperture plate and into the interior space of the carbon gun, forward of the ion chamber, while a shutter or cover plate is rotated in front of the opening in the aperture plate to engage an o-ring associated with the beam collimating ring to seal the interior space during the cleaning cycle.

The beam collimating ring itself has approximately an 80 mm aperture through which the depositing carbon flux flows for linear deposition on a disk substrate. An annular lip of the beam collimating ring protects the o-ring associated with the aperture plate from accumulating scattered carbon during the deposition cycle of the carbon gun.

In the prior art design the aperture plate was given a roughened surface to reduce adhesion of deposited carbon to the plate. Within a relatively short period, however, the aperture plate could generate carbon particles which had a significant, deleterious effect on the corrosion performance of the finished disks having the thin film carbon coat deposited thereon.

In the present invention the aperture plate has been redesigned to increase the size of the annular opening which receives the beam collimating ring. The redesigned aperture plate of the carbon gun significantly increases the annular region of the opening in the aperture plate of the prior art design. Thus, the aperture plate has a reduced surface area, and during the coating cycle, fewer carbon particles attach to the surfaces of the aperture plate of the carbon gun.

Thus, when the beam collimating ring is retracted into the carbon gun interior space during the O₂ plasma cleaning cycle, the re-designed annular region of the aperture plate has a much lower level of carbon deposits. With balanced cleaning and deposition processes, carbon film does not accumulate on exterior of the aperture plate at the levels seen in the prior art design, to substantially increase the number of coating cycles which can be run before a cleaning cycle is needed.

Accordingly, in an apparatus for ion beam deposition on a substrate, said apparatus including a housing having an interior space constructed to hold a chamber which provides for ion beam deposition, powered means for generating a plasma stream in the chamber, an aperture plate disposed in the housing forward of the ion deposition chamber, an annular opening in the aperture plate, and beam collimating means disposed in the annular opening to direct a controlled plasma stream to apply a coating to the substrate during a coating cycle for the apparatus, the present invention provides an improved aperture plate having a reduced surface area to reduce plasma deposition on the plate during the coating cycle, wherein a gas reactive with the plasma material is introduced into the interior of the housing to enable removal of the plasma material deposited within the housing.

The present invention also includes an improved method for cleaning an apparatus for ion beam deposition on a substrate, said apparatus including a housing having an interior space constructed to hold a chamber which provides for ion beam deposition, powered means for generating a plasma stream in the chamber, an aperture plate disposed in the housing forward of the ion deposition chamber, an annular opening in the aperture plate, and beam collimating means disposed in the annular opening to direct a controlled plasma stream to apply a coating to the substrate during a coating cycle for the apparatus, wherein said method includes providing a reduced surface area in the aperture plate to reduce plasma deposition on the plate during the coating cycle, with a gas reactive with the plasma material being introduced into the interior of the housing to enable removal of the plasma material deposited within the housing during the coating cycle.

In the present invention a carbon gun for ion beam deposition comprises an interior space including a plasma chamber constructed for ion beam deposition of a plasma on a disk, power means for generating a plasma in the chamber to be directed at the disk to apply a thin film coating thereto, an aperture plate disposed in the housing forward of the plasma chamber, an annular opening in the aperture plate, and beam collimating means disposed in the annular opening to direct a controlled plasma stream to apply a coating to the disk during a coating cycle for the carbon gun with the disk supported in front of the plasma chamber by a support mechanism which is forward of the carbon gun. During the coating cycle, a carbon film is generated when the precursor gas, in this case acetylene, is ionized in the carbon gun. However the ionized carbon which attaches to the disk as a coating during the coating cycle also attaches to the chamber walls as well as the aperture plate, the beam collimating ring and other associated surfaces exposed to the plasma stream during the coating cycle. After many coating cycles the carbon build up on these surfaces must be removed because carbon particles can attach to a disk inserted into the chamber prior to and during that disk's coating cycle, causing surface irregularities and potential failure sites in the finish coated disk.

Although the use of scrubbing gases are known in the art, the present invention provides an improvement in the carbon gun to minimize accumulation of carbon film on those areas of the gun not exposed to the O₂ plasma. During a cleaning cycle, the interior space of the gun is first sealed; then a gas inlet for the ionization chamber is opened to admit a gas reactive with the accumulated carbon film into the interior space of the gun. In the carbon gun of the present invention, the preferred cleaning gas is oxygen, which reacts with carbon to form carbon dioxide and carbon monoxide gases, which can be vented from the chamber, leaving little if any carbon residue behind.

The present invention provides an improvement particularly useful in the coating of magnetic disks. In particular, the improved carbon gun includes apparatus in which a reduction in the surface area of the aperture plate causes carbon films normally deposited on the exterior of the carbon gun to be instead deposited on the beam collimating ring which is subsequently cleaned by the O₂ plasma during the cleaning cycle.

### BRIEF DESCRIPTION OF THE DRAWINGS

The invention is described in detail below with reference to the following drawings, wherein like reference numerals indicate a corresponding structure throughout the several views.

FIG. 1 is a side plan view of one of the carbon guns which employs the present invention.

FIG. 2A is an end plan view of the opening into the interior space of the carbon gun shown in FIG. 1 following carbon deposition.

FIG. 2B is an end plan view of the opening into the interior space of the carbon gun shown in FIG. 1 following oxygen cleaning.

FIG. 3A is a schematic side elevation of a pair of carbon guns mounted on opposite sides of a coating station for disks, with both guns activated to coat opposite sides of a disk during a coating cycle.

FIG. 3B is a schematic side elevation of a pair of carbon guns mounted on opposite sides of a coating station for disks, wherein a cleaning cycle has been initiated.

FIG. 3C is a schematic side elevation of a pair of carbon guns mounted on opposite sides of a coating station for disks, wherein a cleaning cycle is in progress.

FIG. 4 is a chart showing the significant increase in time of carbon gun operating before defects occur when the preferred design is used.

### DETAILED DESCRIPTION OF THE INVENTION

Definitions and Overview:

Before describing the present invention in detail, it is to be understood that this invention is not limited to specific fluids, biomolecules, or device structures, as such may vary. It is also to be understood that the terminology used herein is for the purpose of describing particular embodiments only, and is not intended to be limiting.

It must be noted that, as used in this specification and the appended claims, the singular forms “a,” “an,” and “the” include both singular and plural referents unless the context clearly dictates otherwise. Thus, for example, reference to “a disk” includes a plurality of disks as well as a single disk, reference to “a characteristic” includes a plurality of characteristics as well as single characteristic, and the like.

In describing and claiming the present invention, the following terminology will be used in accordance with the definitions set out below.

The term “ion” is used in its conventional sense to refer to a charged atom or molecule, i.e., an atom or molecule that contains an unequal number of protons and electrons. Positive ions contain more protons than electrons, and negative ions contain more electrons than protons.

Accordingly, the term “ionization chamber” as used herein refers to a chamber in which ions are formed from fluids or gases input to the chamber.

“Optional” or “optionally” means that the subsequently described circumstance may or may not occur; so that the description includes instances where the circumstance occurs and instances where it does not.

The term “plasma” refers to an ionized gas and is usually considered a distinct phase of matter. “Ionized” means that at least one electron has been removed from a significant fraction of the molecules comprising such gas. The free charges make the plasma electrically conductive so that it couples strongly to electromagnetic fields.

The term “radiation” is used in its ordinary sense and refers to emission and propagation of energy in the form of a waveform disturbance traveling through a medium such that energy is transferred from one particle of the medium to another without causing any permanent displacement of the medium itself. Thus, radiation may refer, for example, to electromagnetic waveforms as well as radio frequency wave forms.

The term “substantially” as in, for example, the phrase “substantially identical elements,” refers to elements that do not deviate by more than 10%, preferably not more than 5%, more preferably not more than 1%, and most preferably at most 0.1% from each other. Similarly, the phrase “substantially identical elements” refers to elements that do not deviate in physical properties. For example “substantially identical elements” differ by more than 10%, preferably not more than 5%, more preferably not more than 1%, and most preferably at most 0.1% from each other. Other uses of the term “substantially” involve an analogous definition.

The term “substrate” as used herein refers to any material having a surface onto which a coating may be applied. In the preferred embodiment of the present invention the substrate is a magnetic disc used in a data storage device such as a disk drive.

While plasma enhanced chemical deposition chemical vapor deposition (PECVD) deposits carbon layers shown to be harder and denser than those produced by conventional sputtering deposition, a key problem of PECVD deposited carbon is the contamination of the carbon film by particles produced inside the carbon source after long-time operation. This particle generation limits runtime for the source drastically.

While it is known to clean such source by an intermittent in situ oxygen plasma process to avoid such particle generation, improvements in the cleaning process provide a significant contribution to instrument operation, reducing down time for the instrument, reducing particle generation and reducing failure rates in the finished disks.

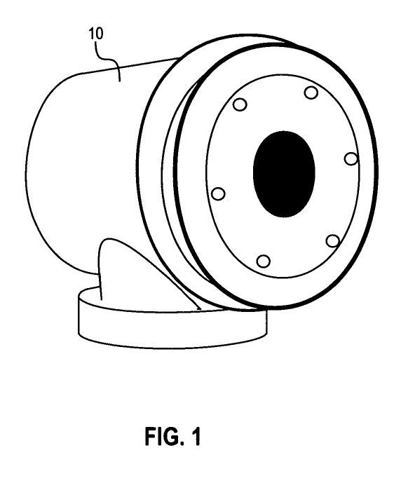

The carbon gun 10 which employs the present invention is shown in the perspective view of FIG. 1. One carbon gun 10 is shown in FIG. 1. The gun uses acetylene (C₂H₂) as a precursor gas. The precursor gas is ionized by the gun 10, producing acetylene (C₂H₂) ions, with ion acceleration directing the acetylene ions toward a magnetic disk mounted in a disk processing station as described below. Unaxis Corporation manufactures a device designated a Carbon Gun in which the improvement of the present invention could be used, although its use is not limited to the Carbon Gun, and its use in the Carbon Gun should not be considered a limitation of the present invention.

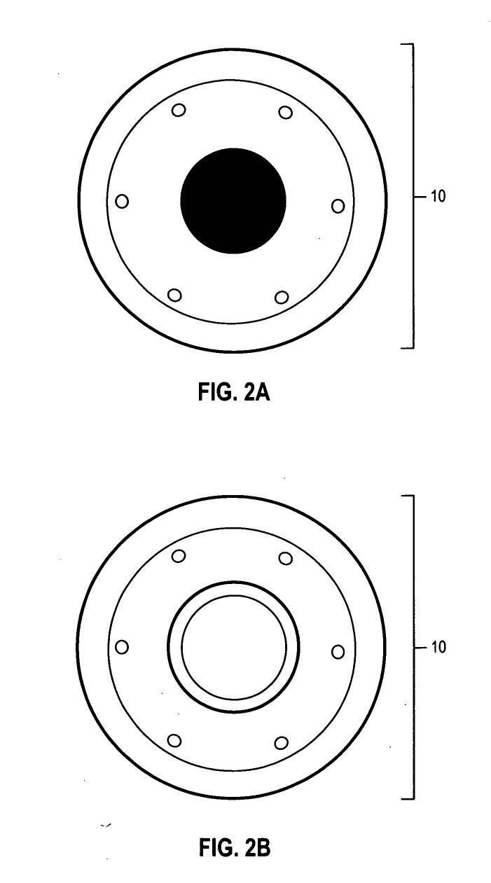

In FIG. 2A, the interior space of the gun 10 is seen after significant carbon deposits have accumulated and before a cleaning cycle has been has initiated.

In FIG. 2B, the interior space of the gun 10 is seen after oxygen cleaning.

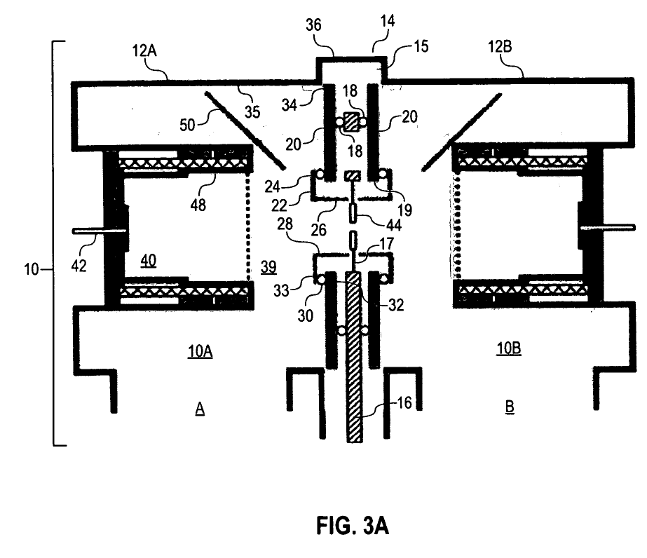

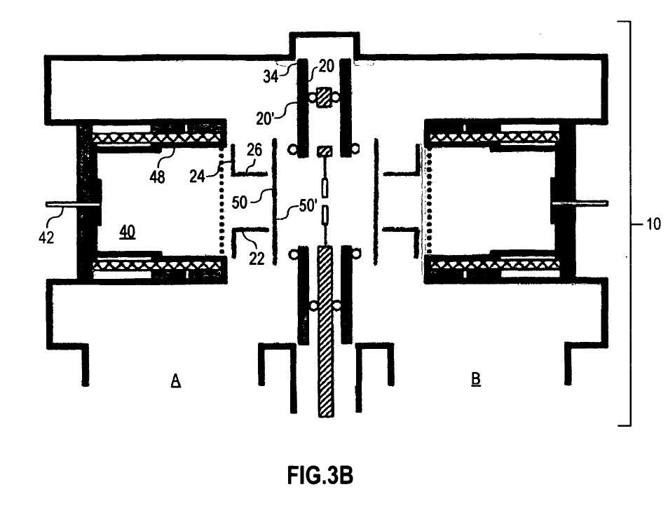

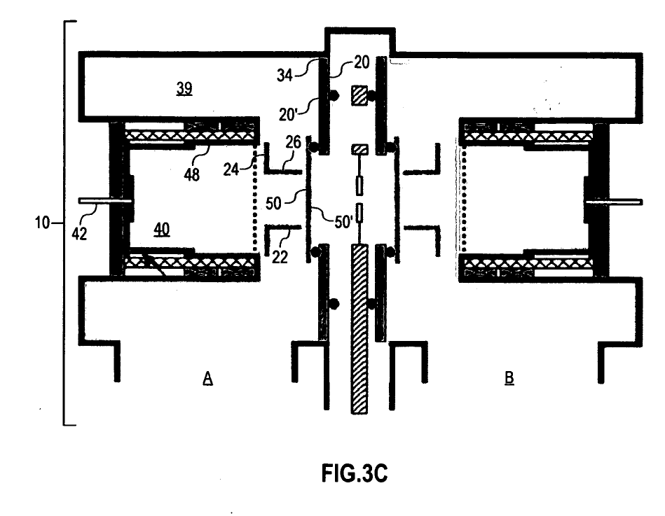

Two carbon guns 10 are schematically shown in FIG. 3, with each carbon gun 10 being the mirror image of the other, and each carbon gun 10 mounted on opposite sides of a disk processing station 14. In FIG. 3A, both guns are in the coating cycle. To aid the reader, the left-hand carbon gun 10 will be designated carbon gun 10A and the right-hand carbon gun 10 will be designated carbon gun 10B. Because the carbon guns 10 share like components, only the left hand carbon gun 10 will be marked with reference numerals for the convenience of the reader. The suffix A or B will not be added to the numeral designating a component unless it is necessary, as when such component is specific to a particular gun 10.

The carbon guns 10 include housings 12A and 12B and are mounted on a processing station 14 but separated from each other by a rotatable disk holder 16 disposed in the processing station 14 between the housings 12A and 12B of carbon guns 10A and 10B but engaged by like elements of the gun disposed in each of the housings 12A and 12B. Separate o-rings 18 are disposed on opposite sides of the disk holder 16. Each gun 10 has a slideable aperture plate 20 which engages an o-ring 18 on opposite sides of the disk holder 16 to provide a sealing surface between housings 12A and 12B. An annular opening 19 in the aperture plate 20 receives a beam collimating ring 22.

The beam collimating ring 22, has an annular outer lip 24, and an annular extension 26 at an inner diameter 28 of the lip 24 generally perpendicular to the lip 24 and extending forward there from, i.e. toward a disk 44 held in the disk holder 16 by grippers 17 of the processing station 14. The annular extension 26 of the beam collimating ring 22 is considerably smaller in diameter than the diameter of the annular opening 19 in the aperture plate 20 to minimize overspray of the disk 44. An o-ring 30 is engaged by an inner edge 32 of the aperture plate 20 adjacent the opening 19 and an outer edge 33 of the lip 24 of the beam collimating ring 22, to seal against the aperture plate 20 and provide a closure between the housings 12A and 12B. The o-ring 30 is protected from carbon deposition by the lip 24 of the beam collimating ring 22.

To complete the separation between the housings 12A and 12B, the outer ends 34 of the aperture plates 20 are disposed adjacent inner walls 35 of the housing 12A and 12B in a protrusion 36 of the processing station 14 between the housings 12A and 12B for carbon guns 10A and 10B respectively.

The housing 12 of each carbon gun 10 includes an interior space 39 holding a plasma chamber 40 for ionizing a precursor gas admitted to the chamber 40 through a gas inlet 42. The ionization process is well known and will be described only in such detail as to provide a framework for the inventive concept set forth herein.

Because the operating cycles of the carbon guns 10 are identical for each gun 10A and 10B, only the operation of the left-hand carbon gun 10A will be discussed in detail below.

The disk or substrate 44 is held in place in the disk holder 16 of the processing station 14 by the grippers 17. During disk processing, the disk holder 16 is rotated about a center of rotation (not shown) to a series of locations in the processing station 14 for a series of steps required in disk processing. At the carbon gun location shown in FIG. 3, the processing station 14 is stopped to align the disk 44 between the guns 10, and the carbon guns 10 are activated to apply a thin film carbon overcoat to opposite sides of the disk 44. During this coating cycle of the gun 10A, the gas inlet 42 is opened to admit a precursor gas into the plasma chamber 40. In the application described herein, acetylene (C₂H₂) is used as the precursor gas, although the use of other carbon-based gases, e.g., methane (CH₄), is possible. Also the precursor gas may be mixed with an inert gas, such as Argon (Ar), to better control the ionization process.

Ionization of the precursor gas generates a cloud of acetylene ions which can be applied to the disk 44 through the beam collimating ring 22 in a controlled manner to provide a thin film of carbon of uniform thickness (2-5 nm) thereon. However, the excess of acetylene ions and carbon containing radicals not used to coat the disk 44 scatter throughout the interior space 39 and the plasma chamber 40 of the housing 12A and coat inner walls 35 of the housing 12A, the interior walls 48 of the plasma chamber 40 and the aperture plate 20. The beam collimating ring 22 shields the o-ring 30 from carbon deposition. Of particular concern is the carbon buildup at the peripheral edges 32 of the aperture plate adjacent the annular opening 19. Over the course of several coating cycles the carbon build up begins to impact negatively on the failure rate for coated disks. Free carbon ions can attach to the disk and produce surface irregularities which can impair disk performance and even disk failure.

While it is known to introduce a reactive gas, such as oxygen (O₂), into an ionization chamber to “scrub” the chamber and reduce carbon build-up, the present invention provides efficiencies not available in the prior art and particularly useful in the cleaning cycle.

In the coating cycle, a shutter or cover plate 50 is disposed in the interior of the housing 12A adjacent the plasma chamber 40, but tipped out of the path between the front of the plasma chamber 40, the beam collimating ring 22 and the disk 44 so as not to interfere with the coating cycle.

To initiate the cleaning cycle, as shown in FIG. 3B, the carbon gun 10 is in an idle mode, with the ionization chamber 40 not in use and the source of precursor gas disconnected there from. The beam collimating ring 22 is drawn into the interior of the housing 12A, with the lip 24 of the beam collimating ring 22 adjacent to but not touching the front of the ionization chamber 40. The annular extension 26 of the ring 22 has been withdrawn from the disk processing station 14 between the housings 12A and 12B, and the opening 19 in the aperture plate 20, to be fully contained within the interior 39 of the housing 12A. The shutter 50 is then rotated, as shown in FIG. 3B, and placed in a fixed position in generally parallel alignment with the opening 19 in the aperture plate 20 but separated from both the end of extension 26 and the aperture plate 20.

As shown in FIG. 3C, axial movement of the aperture plate 20 along the interior wall 35 of the housing 12A, separates the aperture plate 20 from the o-ring 18 and enables the o-ring 30 to be clamped between the an outer wall 50′ of the shutter 50 and an inner wall 20′ of the aperture plate 20.

With the interior compartment of the housing 12A so sealed, a cleaning gas, e.g. oxygen, is introduced into the interior compartment 39 of the housing 12A. Reference may be had to “In Situ Oxygen Plasma Cleaning of a PECVD Source for Hard Disk Overcoats” by D. Ochs and B. Cord, infra, for a more detailed discussion of the cleaning process.

The opening 19 in the aperture plate 20 of the present invention has been enlarged to expose less aperture plate surface to carbon ions during the coating cycle. These changes to the carbon gun structure have resulted in a significant increase in carbon gun operation before defects occur. In particular, the number of disk coating cycles before a system clean is required has been increased by a factor of seven.

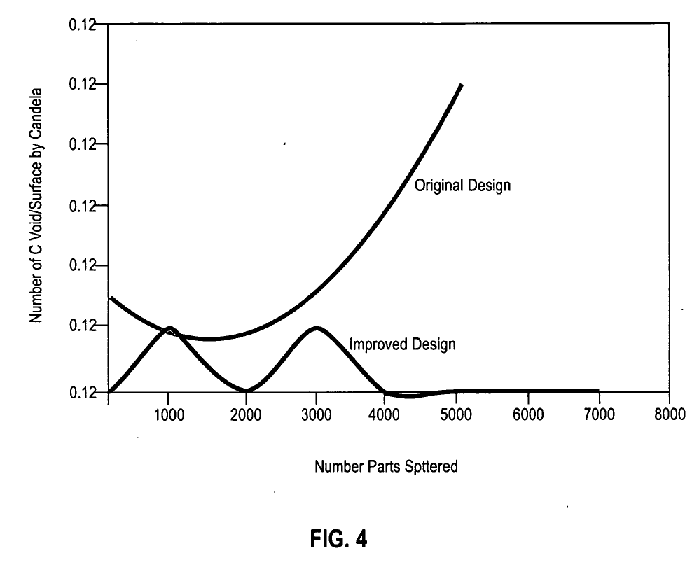

FIG. 4 demonstrates a continuing low level of defects for the number of parts sputtered using the improved design (9000+parts), while the original design for the carbon gun shows a sharp rise in defects after as few as fourteen hundred (1400) parts have been sputtered. Thus a relatively small reduction in surface area for the aperture plate 20 has resulted in a seven fold increase in productivity for the carbon gun, i.e., there is a seven fold increase in the output of coated disks by the gun before there is a need to initiate a cleaning cycle.

It is to be understood that while the invention has been described in conjunction with the preferred specific embodiments thereof, the foregoing description, as well as the examples that follow, is intended to illustrate and not limit the scope of the invention. Other aspects, advantages and modifications will be apparent to those skilled in the art to which the invention pertains.

All patents, patent applications, journal articles and other references cited herein are incorporated by reference in their entireties.

We claim:

1. In an improved apparatus for ion beam deposition on a substrate, said apparatus including a housing having an interior space constructed to hold a chamber which provides for ion beam deposition, powered means for generating a plasma stream in the chamber, an aperture plate disposed in the housing forward of the ion deposition chamber, an annular opening in the aperture plate, beam collimating means disposed in the annular opening to direct a controlled plasma stream to apply a coating to the substrate during a coating cycle for the apparatus, and sealing means engageable with the aperture plate, the improvement comprising an aperture plate having a reduced surface area to reduce plasma deposition on the aperture plate during the coating cycle, thereby to minimize deposition of carbon films on areas of the apparatus not subjected to cleaning during a cleaning cycle for the apparatus, wherein a gas reactive with the plasma material is introduced into the interior of the housing to enable removal of the plasma material deposited within the interior space of the housing.

2. The improved apparatus as claimed in claim 1 wherein the annular opening in the aperture plate is enlarged to reduce the surface area of the aperture plate exposed to the deposition of carbon particles thereon during the coating cycles of the apparatus.

3. The improved apparatus as claimed in claim 2 wherein the aperture plate is disposed at the front end of the housing between the chamber and the substrate.

4. The improved apparatus as claimed in claim 3 wherein the beam collimating means includes an annular lip engageable with the aperture plate when the beam collimating means is mounted in the annular opening of the aperture plate.

5. The improved apparatus as claimed in claim 4 wherein an o-ring is disposed between the aperture plate and the beam collimating means and protected from carbon deposition during the coating cycle of the apparatus by a lip provided on the portion of the beam collimating ring disposed adjacent the aperture plate.

6. The improved apparatus as claimed in claim 3 wherein the beam collimating means comprises a ring having an inner extension directed toward the substrate and an outer lip engaging an o-ring disposed between the lip and the aperture plate to shield the o-ring and the annular edge of the opening in the aperture plate from carbon film deposition during a coating cycle for the apparatus.

7. The improved apparatus as claimed in claim 6 including retraction means for engaging the beam collimating ring and drawing it into the interior of the housing during a cleaning cycle for the apparatus.

8. The improved apparatus as claimed in claim 1 wherein the substrate comprises a magnetic disk.

9. The improved apparatus in claim 1 wherein the sealing means includes a moveable shutter or cover plate overlying the opening in the aperture plate during a cleaning cycle of the apparatus.

10. The improved apparatus in claim 9 wherein the sealing means includes an o-ring engaging the moveable shutter or cover plate.

11. The improved apparatus in claim 10 wherein the sealing means includes a slideable aperture plate facing the moveable shutter or cover plate.

12. The improved apparatus in claim 11 wherein the o-ring is clamped between the moveable shutter and the slideable aperture plate to provide a seal for a forward end of the housing during a cleaning cycle for the apparatus.

13. In an improved method for cleaning an apparatus for ion beam deposition, said apparatus including a housing having inside walls and constructed to hold a chamber which provides for ion beam deposition, an aperture plate disposed in front of the ion deposition chamber, a beam collimating ring disposed in an annular opening in the aperture plate and powered means for generating a plasma in the chamber to be to directed to the substrate to apply a coating thereto, cleaning apparatus for cleaning the interior of the housing and the chamber therein of plasma material deposited within the housing during a coating cycle for the substrate, said improved method comprises the steps of providing an enlarged opening in the aperture plate to reduce the surface area to be cleaned, drawing the beam collimating ring into the interior of the housing with retraction means for cleaning, sealing the housing with sealing means, and enabling entry of a reactive gas into the interior of the housing through gas inlet means during a cleaning cycle, said gas reactive with the plasma material deposited in the inside walls of the housing to enable removal of plasma material deposited within the interior space of the housing.

14. The improved method as claimed in claim 13 including the step of rotating a shutter or cover plate to be disposed between the beam collimating ring and the opening in the aperture plate.

15. The improved method as claimed in claim 14 including the step of providing the beam collimating ring with an inner extension directed toward the substrate and an outer lip engaging the o-ring, thereby protecting the o-ring and the annular edge of the opening in the aperture plate from carbon deposition during the coating cycle.

16. The improved method of claim 13 wherein the drawing into step includes using retraction means to engage the beam collimating ring and draw it into the interior of the housing for cleaning.

17. The improved method of claim 13 wherein the sealing step includes rotating a moveable shutter into position to engage one side of an o-ring of the sealing means.

18. The improved method of claim 17 wherein the sealing step includes moving a slideable aperture plate to engage an opposite side of the o-ring.

19. The improved method of claim 18 wherein the sealing step includes clamping the o-ring between the moveable shutter and the slideable aperture plate to create a seal.

20. In an improved apparatus for ion beam deposition on a substrate, said apparatus including a pair of housings, each having an interior space constructed to hold a chamber which provides for ion beam deposition, powered means for generating a plasma stream in the chamber, an aperture plate disposed in each housing forward of the ion deposition chamber, an annular opening in the aperture plate, beam collimating means disposed in the annular opening to direct a controlled plasma stream to apply a coating from each housing to opposite sides of the substrate during a coating cycle for the apparatus, and a sealing means engaging the aperture plate to seal the housing, the improvement comprising an aperture plate having a reduced surface area to reduce plasma deposition on the plate during the coating cycle, thereby to minimize deposition of carbon films on areas of the apparatus not subjected to cleaning during a cleaning cycle for the apparatus, wherein a gas reactive with the plasma material is introduced into the interior of the housing to enable removal of the plasma material deposited within the interior space of the housing.

21. In an improved carbon gun for ion beam deposition on a substrate, said carbon gun including a housing having an interior space constructed to hold an ion beam deposition chamber, powered means for generating a plasma stream in the chamber, an aperture plate disposed in the housing forward of the ion beam deposition chamber, an annular opening in the aperture plate, and a beam collimating ring disposed in the annular opening to direct a controlled plasma stream to apply a coating to the substrate during a coating cycle for the carbon gun, the improvement comprising an aperture plate having a reduced surface area to reduce plasma deposition on the plate during the coating cycle, thereby to minimize deposition of carbon films on areas of the apparatus not subjected to cleaning during a cleaning cycle for the apparatus, wherein a gas reactive with the plasma material is introduced into the interior of the housing to enable removal of the plasma material deposited within the interior space of the housing.
